(19) United States
(12) Patent Application Publication
(10) Pub. No.: US 2020/0143762 A1
(43) Pub. Date: May 7, 2020

(54) DISPLAY DRIVING DEVICE, DISPLAY DEVICE AND DISPLAY MODULE

(71) Applicants: HKC Corporation Limited, Shenzhen (CN); Chongqing HKC Optoelectronics Technology Co., Ltd., Chongqing (CN)

(72) Inventor: Xiaoyu Huang, Shenzhen (CN)

(21) Appl. No.: 16/257,076

(22) Filed: Jan. 25, 2019

Related U.S. Application Data
(63) Continuation of application No. PCT/CN2018/115779, filed on Nov. 16, 2018.

(30) Foreign Application Priority Data
Nov. 1, 2018 (CN) 201811299708.6

(51) Int. Cl. G09G 3/36

(52) U.S. Cl. CPC G09G 3/3648; G09G 2330/021; G09G 2300/0426; G09G 2320/0626

(57) ABSTRACT

Disclosed are a display driving device, display device and display module, the display driving device comprising: a drive controller, for outputting a drive control signal to perform drive control on a display pixel; and an auxiliary control circuit, connected, when the signal output of the drive controller is abnormal, to an output terminal of the drive controller, and outputting an auxiliary control signal to perform drive control on the display pixel.

The present application is a Continuation Application of PCT Application No. PCT/CN2018/115779 filed on Nov. 16, 2018, which claims the benefit of Chinese Patent Application No. 201811299708.6, filed with the Chinese Patent Office on Nov. 1, 2018 and entitled “display driving device, display device and display module”, which is incorporated herein by reference in its entirety.

### FIELD OF THE DISCLOSURE

The present application relates to the technical field of displays, and particularly, to a display driving device, display device and display module.

### BACKGROUND OF THE DISCLOSURE

The statement herein only provides the background related to the present application, but not necessarily forms the prior art.

Display device, such as a thin film transistor liquid crystal display (TFT-LCD), has become indispensable for modern IT and video products.

However, when existing display devices perform drive display, the requirement for controlling various types of driver chips is difficult to be satisfied during product production at a later stage due to a design limit of a drive controller, with the result that the product cannot be used normally, and the reword cost of the product is improved.

### SUMMARY OF THE DISCLOSURE

An embodiment of the present application provides a display driving device, display device and display module, ensuring that the drive design of the drive controller can satisfy various types of drivers chips.

An embodiment of the present application provides a display driving device, comprising:

A drive controller, for outputting a drive control signal to perform drive control on a display pixel; and

An auxiliary control circuit, connected, when the signal output of the drive controller is abnormal, to an output terminal of the drive controller, and outputting an auxiliary control signal to perform drive control on the display pixel.

An embodiment of the present application further provides a display device, comprising a display pixel, a first driver chip and a second driver chip for brightening the display pixel, and a drive controller for driving the first driver chip and the second driver chip to operate; the display device further comprises:

An auxiliary control circuit, connected, when the signal output of the drive controller for driving the first driver chip and the second driver chip to operate is abnormal, to an output terminal of the drive controller, and outputting an auxiliary control signal to perform drive control on the display pixel.

An embodiment of the present application further provides a display module, comprising:

A substrate, forming thereon a display area comprising a plurality of display pixels;

At least one first driver chip, electrically connected to the display pixels in the display area;

At least one second driver chip, electrically connected to the display pixels in the display area;

A drive controller, for generating and correspondingly outputting drive control signals to the first driver chip and/or the second driver chip, controlling the first driver chip and/or the second driver chip to generate drive signals to brighten the display pixels; and

An auxiliary control circuit, connected, when the signal output of the drive controller is abnormal, to an output terminal of the drive controller, and outputting an auxiliary control signal to control the first driver chip and/or the second driver chip to generate the drive signal.

In the technical solution of the present application, owing to the adding of the auxiliary control circuit, the drive controller, even having a design limit, can still output a driver chip required control signal to drive different types of driver chips to generate drive signals, thus ensuring the normal operation of the display device, and saving the rework cost of the product.

### BRIEF DESCRIPTION OF THE DRAWINGS

FIG. 1 is a structural schematic view of the display device according to one embodiment of the present application;

FIG. 2 is a schematic view of the functional structure of the display driving device according to one embodiment of the present application;

FIG. 3 is a schematic view of the functional structure of the display driving device in one state according to one embodiment of the present application;

FIG. 4 is a schematic view of the functional structure of the display driving device in another state according to one embodiment of the present application;

FIG. 5 is a schematic view of the functional structure of the display driving device in one state according to another embodiment of the present application;

FIG. 6 is a schematic view of the functional structure of the display driving device in another state according to another embodiment of the present application;

FIG. 7 is a schematic view of the circuit structure of the display driving device according to one embodiment of the present application;

FIG. 8a and FIG. 8b are schematic views showing the circuit connection of the display driving device in FIG. 7 when the signal output of the drive controller is abnormal; and

FIG. 9 is a schematic view showing the circuit connection of the display driving device in FIG. 7 when the signal output of the drive controller is normal.

### DETAILED DESCRIPTION OF THE EMBODIMENTS

To better understand the technical solution above, the exemplary embodiments of the present disclosure will be described in details hereafter with reference to the drawings. Although the exemplary embodiments of the present disclosure are shown in the drawings, it should be understood that the present disclosure can be realized in various forms and shall not be limited to the embodiments elaborated herein. On the contrary, the embodiments are provided such that the present disclosure can be understood more thoroughly and the scope of the present disclosure can be completely conveyed to a person skilled in the art.

It should be noted that, if the embodiments of the present application have a directional indication (such as up, down, left, right, front, back, . . . ), then the directional indication is only used to explain the relative position relationship, the motion condition and the like between the components under a specific attitude (as shown in the drawings), and if the specific attitude changes, then the directional indication also changes accordingly.

In addition, if the embodiments of the present application relates to the descriptions of “first”, “second” and the like, the descriptions are only used for the purpose of description only, and are not to be construed as indicating or implying the relative importance thereof or implicitly indicating the number of indicated technical features. Thus, a feature defined by “first” or “second” may explicitly or implicitly comprise at least one of the features. In addition, the technical solutions of various embodiments may be combined with each other only on the basis that a person skilled in the art can realize the combination; when the combination of the technical solutions contradicts each other or is impossible to realize, the combination of the technical solutions should be considered to be non-existent, nor is not in the protection scope claimed by the present application.

In order to solve the technical problem in a display device that the requirement for driving various types of driver chips is difficult to be satisfied during product production at a later stage due to a design limit of a drive controller at an earlier stage, an embodiment of the present application provides a novel driving solution, namely an auxiliary control circuit which can, when the drive controller cannot satisfy the driving requirement due to the design limit, replace the drive controller to output a corresponding control signal to control the driver chips to operate.

To facilitate the understanding of the embodiments of the present application, before the specific embodiments of the present application are described, a brief introduction will be made to the driving principle of the display device according to the structure of one embodiment.

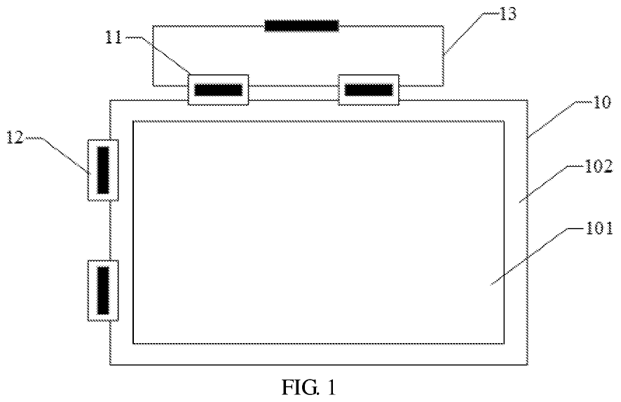

Reference is made to FIG. 1 which is a structural schematic view of the display device according to one embodiment of the present application. The display device comprises a substrate 10, at least one first driver chip 11, at least one second driver chip 12, and a drive controller 13. Specifically,

A display area 101 and a non-display area 102 are formed on the substrate 10, wherein the display area 101 comprises a plurality of display pixels which can be distributed in rows and columns to form a matrix structure; and certainly, the display pixels are not limited to the matrix arrangement structure, and can also adopt other arrangement patterns.

Alternatively, a crosswise arranged signal circuit and a switching device are also formed in the display area 101; the signal circuit may specifically comprise a first signal line and a second signal line electrically connected to the switching device; the switching device is configured to be activated when a first drive signal is received from the first signal line, in which case the display pixels would receive a second drive signal from the second signal line via the activated switching device, and would be brightened according to the second drive signal. Specifically, the switching element can comprise, but not limited to, a thin film transistor (TFT (Thin Film Transistor), and can further comprise, for example, a field effect transistor, a triode and the like. The first signal line and the second signal line can also be entitled as a scanning line and a data line.

The at least one first driver chip 11 is electrically connected to the signal circuit in the display area 101, for example, connected to the first signal line, and electrically connected to the display pixels via the first signal line. The first driver chip 11 provides the first drive signal.

The at least one two driver chip 12 is electrically connected to the signal circuit in the display area 101, for example, connected to the second signal line, and electrically connected to the display pixels via the second signal line. The second driver chip 12 provides the second drive signal.

The drive controller 13 is electrically connected to the first driver chip 11 and/or the second driver chip 12, is configured to generate and correspondingly output drive control signals to the first driver chip 11 and/or the second driver chip 12, and control the first driver chip 11 and/or the second driver chip 12 to generate drive signals. The display pixels are driven to be brightened via the drive signals provided by the first driver chip 11 and the second driver chip 12.

Alternatively, the drive control signal provided by the drive controller 13, for example, comprises a frame start pulse signal STV, a pulse signal TP, a clock signal CKV, an enable signal OE and the like, wherein the enable signal OE is configured to control the driver chips to operate. However, different driver chips determine the enable signal differently, for example, a driver chip A is activated to operate when a high level signal is received, and a driver chip B is activated to operate when a low voltage signal is received. The drive controller 13 cannot simultaneously drive the two types of driver chips, thus the display device cannot be normally used.

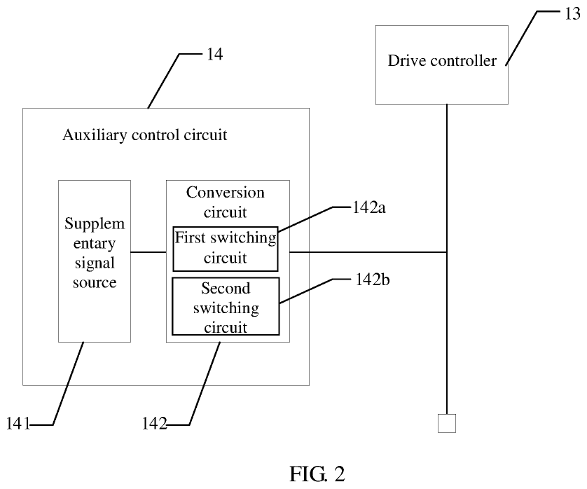

Reference is made to FIG. 2 which is a schematic view of the functional structure of the display driving device according to one embodiment of the present application. The technical solution of the present application provides a novel display driving device. In the technical solution, an auxiliary control circuit 14 added; when the signal output of the drive controller 13 is abnormal, the auxiliary control circuit 14 is connected to the output terminal of the drive controller 13, outputs an auxiliary control signal, and replace the drive controller 13 to control the driver chips to output drive signals, thus controlling the drive of the display pixels.

Owing to the adding of the auxiliary control circuit 14, the drive controller 13, even having a design limit, can still output a driver chip required control signal to drive different types of driver chips to generate drive signals, thus ensuring the normal operation of the display device, and saving the rework cost of the product.

In one embodiment of the present application, the auxiliary control circuit 14 comprises:

A supplementary signal source 141, for generating a supplementary power signal; and

A conversion circuit 142, for receiving the supplementary power signal, and converting the supplementary power signal into an auxiliary control signal.

Specifically, the supplementary power signal generated by the supplementary signal source 141, for example, comprises a high voltage signal and/or a low voltage signal. The conversion circuit 142 converts the supplementary power signal into an auxiliary control signal. The high voltage signal, once received, is converted to a high level signal; and the low voltage signal, once received, is converted to a low voltage signal. The supplementary signal source 141 and the conversion circuit 142, can generate, when the signal output of the drive controller 13 is abnormal, a logic signal required for driving the driver chips, thus ensuring the normal operation of the display device. It should be noted that the high voltage signal and the low voltage signal represent a relative relationship therebetween only, but do not represent specific voltage values. When the auxiliary control circuit operates, the conversion circuit 142 receives the high voltage signal or the low voltage signal. Namely, when the driver chips require a low voltage signal, the conversion circuit 142 receives the low voltage signal, and converts the low voltage signal into an auxiliary control signal of the low voltage signal; and when the driver chips require a high voltage signal, the conversion circuit 142 receives the high voltage signal, and converts the high voltage signal into an auxiliary control signal of the high level signal.

Alternatively, the supplementary signal source may comprise a high voltage signal source and a low voltage signal source; when the driver chips require a low voltage signal, the high voltage signal source is controlled to connect to the conversion circuit 142; and when the driver chips require a high level signal, the low voltage signal source is controlled to connect to the conversion circuit 142. Certainly, in other embodiments, the supplementary signal source can also be configured to output both a high voltage signal and a low voltage signal.

In one embodiment of the present application, the conversion circuit 142 may comprise:

A first switching circuit 142a, comprising a first control terminal, a first input terminal, and a first output terminal, wherein the first control terminal is electrically connected to an output terminal of the supplementary signal source 141; the first input terminal is connected to a first input signal source; and the first output terminal is an output terminal of the auxiliary control circuit 14, and is configured to output the auxiliary control signal; and

A second switching circuit 142b, comprising a second control terminal, a second input terminal, and a second output terminal, wherein the second control terminal is electrically connected to an output terminal of the supplementary signal source 141; the second input terminal is connected to a second input signal source; and the second output terminal is an output terminal of the auxiliary control circuit 14, and is configured to output the auxiliary control signal;

In the first switching circuit 142a and the second switching circuit 142b, one switching circuit is activated to operate only if a high voltage signal is received, and the other switching circuit is activated to operate only if a low voltage signal is received. Therefore, the first switching circuit 142a and the second switching circuit 142b, no matter a high voltage signal or a low voltage signal is received, can convert the voltage signal into an auxiliary control signal, thus controlling the display of the display pixels.

Alternatively, the first switching circuit 142a may comprise at least one first switching transistor which is a P-type transistor, namely a hole-type semiconductor transistor. The first switching transistor is activated to operate when a gate electrode thereof receives the low voltage signal, and stops operating when the gate electrode receives the high level signal.

The second switching circuit 142b may comprise at least one second switching transistor which is an N-type transistor, namely an electron-type semiconductor transistor. The second switching transistor is activated to operate when a gate electrode thereof receives the high level signal, and stops operating when the gate electrode receives the low voltage signal.

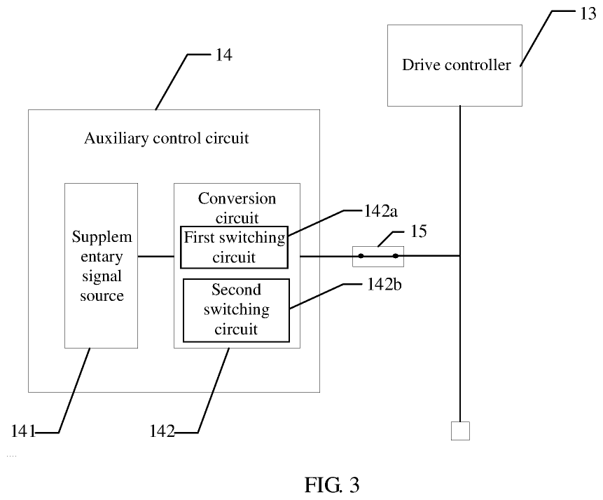

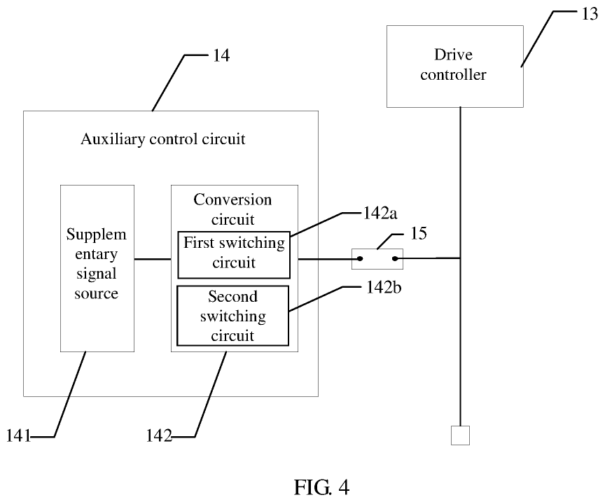

Reference is made to FIG. 3 which is a schematic view of the functional structure of the display driving device in one state according to one embodiment of the present application, and FIG. 4 which is a schematic view of the functional structure of the display driving device in another state according to another embodiment of the present application. In one embodiment of the present application, a first disconnection node 15 is disposed between the output terminal of the auxiliary control circuit 14 and the output terminal of the drive controller 13. As shown in FIG. 3, when the drive controller 13 is abnormal, the first disconnection node 15 is connected. In this case, the drive controller 13 does not output a signal due to abnormal signal output; the first disconnection node 15 is connected; and the output terminal of the auxiliary control circuit 14 outputs an auxiliary control signal to control the drivers chips to operate. Certainly, as shown in FIG. 4, when the drive controller 13 is normal, the first disconnection node 15 is disconnected. In this case, the drive controller 13 generates a control signal to control the driver chips to operate.

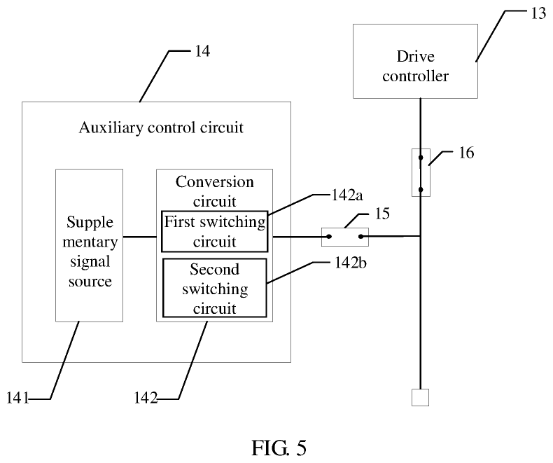

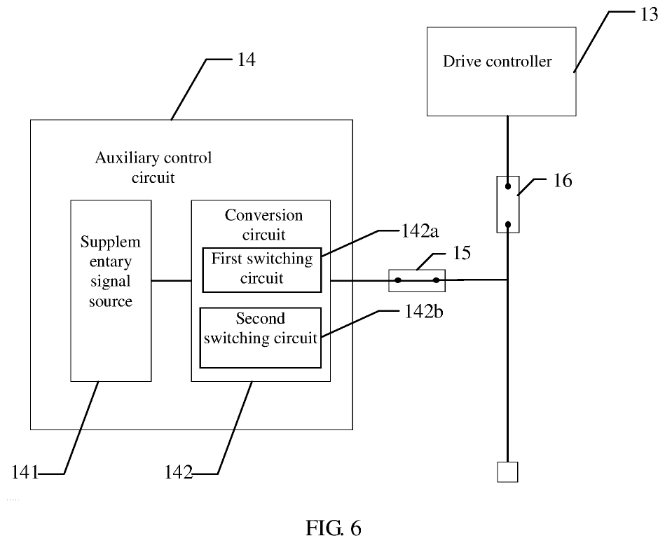

Reference is made to FIG. 5 which is a schematic view of the functional structure of the display driving device in one state according to another embodiment of the present application, and FIG. 6 which is a schematic view of the functional structure of the display driving device in another state according to another embodiment of the present application. In one embodiment of the present application, a second disconnection node 16 is disposed at output terminal of the drive controller 13. As shown in FIG. 5, when the drive controller 13 is normal, the first disconnection node 15 is disconnected, and the second disconnection node 16 is connected. In this case, the drive controller 13 generates a control signal to control the driver chips to operate. As shown in FIG. 6, when the drive controller 13 is abnormal, the first disconnection node 15 is connected, and the second disconnection node 16 is disconnected. In this case, the auxiliary control circuit 14 generates an auxiliary control signal to control the driver chips to operate. Therefore, the disposal of the second disconnection node 16 ensures that the drive controller 13, when abnormal, does not output a control signal, and the auxiliary control circuit 14 controls the driver chips to operate.

Alternatively, the first disconnection node 15 and the second disconnection node 16 can be disposed at device reserved positions. Specifically, the positions for the nodes can be reserved during the formation of the display driving device, and are in a disconnected state. If the node position requires to be connected, then a device, for example a resistor, can be placed at the reserved position to connect the disconnection node. If the node position does not require to be connected, then no device is placed at the reserved position, and the disconnection node is in the disconnected state.

Certainly, in other embodiments, another control solution can also be configured. Namely, when the drive controller is abnormal, the auxiliary control circuit 14 outputs an auxiliary control signal to control the driver chips to operate; and when the drive controller 13 is normal, the auxiliary control circuit 14 does not output an auxiliary control signal, and the drive controller 13 outputs a drive control signal to control the driver chips to operate. Specifically, for example, a functional device similar to a double-knife switch is disposed; when the drive controller is abnormal, the functional device is controlled to connect the input terminals of the driver chips to the auxiliary control circuit; and when the drive controller is normal, the functional device is controlled to connect the input terminals of the driver chips to the drive controller.

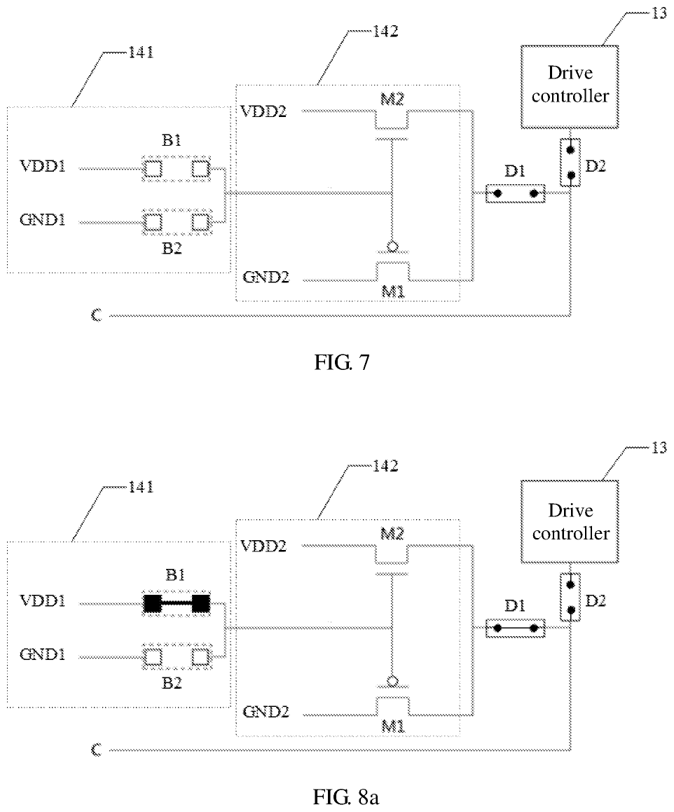

Reference is made to FIG. 7 which is a schematic view of the circuit structure of the display driving device according to one embodiment of the present application. On the basis of the above-described embodiments, an embodiment of the present application provides a specific circuit structure of the display driving device. The auxiliary control circuit in the display driving device comprises a high voltage power supply VDD1, a low voltage power supply GND1, a first switching transistor M1, a second switching transistor M2, a first input power supply VDD2, a second input power supply GND2, a first disconnection node D1, a second disconnection node D2, a first solder pad position B1 and a second solder pad position B2.

Wherein the high voltage power supply VDD1 is connected to one terminal of the first solder pad position B1; the other terminal of the first solder pad position B1 is connected to a gate electrode of the first switching transistor M1; a source electrode of the first switching transistor M1 is connected to the first input power supply VDD2; and a drain electrode of the first switching transistor M1 is connected to one terminal of the first disconnection node D1.

The low voltage power supply GND1 is connected to one terminal of the SECOND solder pad position B2; the other terminal of the second solder pad position B2 is connected to a gate electrode of the second switching transistor M2; a source electrode of the second switching transistor M2 is connected to the second input power supply GND2; and a drain electrode of the second switching transistor M2 is connected to one terminal of the first disconnection node D1.

The output terminal of the drive controller 13 is connected to one terminal of the second disconnection node D2; and the other terminal of the second disconnection node D2 is connected to the other terminal of the first disconnection node D1, and is then connected to a signal input port of the driver chip.

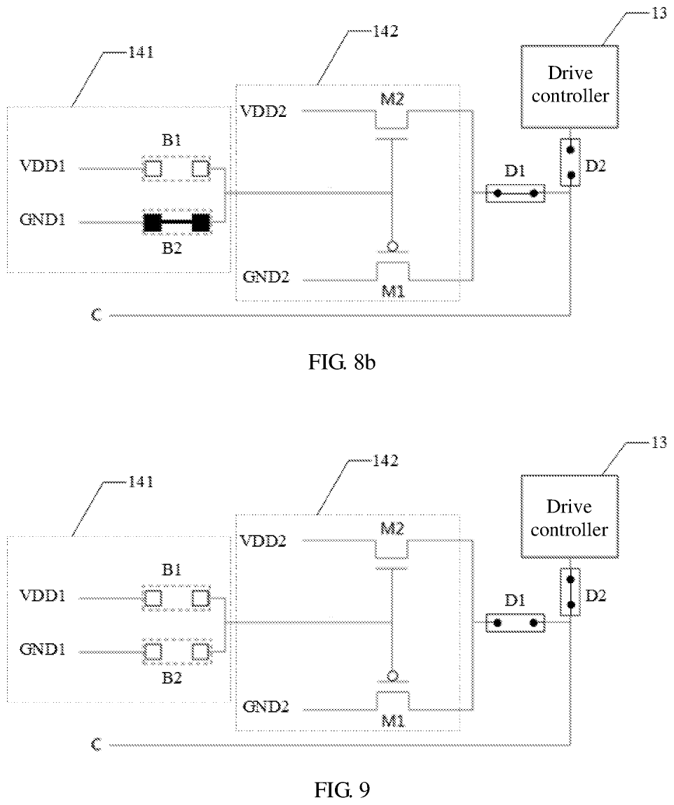

Reference is made to FIG. 8a and FIG. 8b which are schematic views showing the circuit connection of the display driving device in FIG. 7 when the signal output of the drive controller is abnormal. When the drive controller is abnormal, the second disconnection node D2 is in the disconnected state; a first resistor R1 is placed on the first disconnection node D1, namely the first disconnection node D1 is in a connected state. Furthermore, the first solder pad position B1 and the second solder pad position B2 are correspondingly connected according to the control signal required for the driver chips. Specifically, as shown in FIG. 8a, when the control signal required for the driver chips is a high level signal, the first solder pad position B1 is welded to connect the high voltage power supply VDD1 to both the gate of the first switching transistor M1 and the gate electrode of the second switching transistor M2. As shown in FIG. 8b, when the control signal required for the driver chips is a low voltage signal, the second solder pad position B2 is welded to connect the low voltage power supply GND2 to both the gate of the first switching transistor M1 and the gate electrode of the second switching transistor M2.

On the basis of the above-described circuit structure, when the display driving device operates, if the drive controller 13 is abnormal, then the auxiliary control circuit 14 controls the driver chips to operate, thus ensuring the normal operation of the display device.

Reference is made to FIG. 9 which is a schematic view showing the circuit connection of the display driving device in FIG. 7 when the signal output of the drive controller 13 is normal. When the drive controller 13 is normal, the first solder pad position B1 and the second solder pad B2 are in the disconnected state; the first disconnection node D1 is also in the disconnected state; and a second resistor R2 is placed on the second disconnection node D2. On the basis of the circuit structure, when the display driving device operates, if the drive controller 13 is normal, then the drive controller 13 controls the driver chips to operate, thus ensuring the normal operation of the display device.

In the display driving device, the supplementary signal source 141 is located in the non-display area 102. Alternatively, a circuit binding area 103 is also disposed in the non-display area 102; and the supplementary signal source 141 is located in the circuit binding area 103. Specifically, the first solder pad position B1 and the second solder pad position B2 in the supplementary signal source 141 are located in the circuit binding area 103. With the above-described structure configuration, the utilization of the regional characteristics of the circuit binding area 103 ensures that the processing of the first solder pad position B1 and the second solder pad position B2 in the supplementary signal source 141 is easier.

In the display driving device, the conversion circuit 142 is also located in the non-display area 102. Alternatively, the switching unit of the conversion circuit 142 and the switching device of the display area 101 are formed together. Therefore, the manufacturing process of the conversion circuit 142 is easier and simpler.

It should be noted that in the claims, any reference symbols in brackets shall not constitute a restriction to the claims. The word “comprise” does not exclude the components or steps not listed in the claims. The word “one” or “a/an” before a component does not exclude the existence of a plurality of such components. The present application can be realized by means of hardware comprising a plurality of different components and a properly-programmed computer. In a unit claim listing a plurality of devices, the plurality of the devices can be specifically embodied through the same hardware. The use of the words “first”, “second”, “third” and the like does not represent any sequence. The words can be interpreted as names.

Although alternative embodiments of the present application are already described, once basic creative concepts are understood, a person skilled in the art can make further variations and modifications to the embodiments. Therefore, the appended claims are intended to comprise alternative embodiments and all the variations and modifications falling in the scope of the present application.

It will be apparent to those skilled in the art that various modifications and variations of the present application may be made without departing from the spirit or scope of the application. If these various modifications and variations of the present application belong to the scope of the claim and equivalent technical scope, the present application is intended to comprise these modifications and variations.

What is claimed is:

1. A display driving device, comprising:
a drive controller, for outputting a drive control signal to perform drive control on a display pixel; and
an auxiliary control circuit, connected, when the signal output of the drive controller is abnormal, to an output terminal of the drive controller, and outputting an auxiliary control signal to perform drive control on the display pixel.

2. The display driving device according to claim 1, wherein the auxiliary control circuit comprises:
a supplementary signal source, for generating a supplementary power signal; and
a conversion circuit, for receiving the supplementary power signal, and converting the supplementary power signal into the auxiliary control signal.

3. The display driving device according to claim 2, wherein the supplementary power signal comprises a high voltage signal and/or a low voltage signal.

4. The display driving device according to claim 2, wherein the supplementary signal source comprises a high voltage signal source and a low voltage signal source.

5. The display driving device according to claim 2, wherein the conversion circuit comprises:
a first switching circuit, comprising a first control terminal, a first input terminal, and a first output terminal, wherein the first control terminal is electrically connected to an output terminal of the supplementary signal source; the first input terminal is connected to a first input signal source; and the first output terminal is an output terminal of the auxiliary control circuit, and is used to output the auxiliary control signal; and
a second switching circuit, comprising a second control terminal, a second input terminal, and a second output terminal, wherein the second control terminal is electrically connected to an output terminal of the supplementary signal source; the second input terminal is connected to a second input signal source; and the second output terminal is an output terminal of the auxiliary control circuit, and is used to output the auxiliary control signal.

6. The display driving device according to claim 5, wherein the first switching circuit comprises at least one first switching transistor; the second switching circuit comprises at least one second switching transistor; in the first switching circuit and the second switching circuit, one switching circuit is activated to operate when the high voltage signal is received, and the other switching circuit is activated to operate when the low voltage signal is received.

7. The display driving device according to claim 5, wherein the first switching circuit comprises at least one hole-type semiconductor transistor; and the second switching circuit comprises at least one electron-type semiconductor transistor.

8. The display driving device according to claim 1, wherein a first disconnection node is disposed between the output terminal of the auxiliary control circuit and the output terminal of the drive controller; and when the signal output of the drive controller is abnormal, the first disconnection node is connected.

9. The display driving device according to claim 8, wherein a second disconnection node is disposed at the output terminal of the drive controller; and when the signal output of the drive controller is normal, the second disconnection node is connected, and the first disconnection node is disconnected.

10. The display driving device according to claim 9, wherein the first disconnection node and the second disconnection node are disposed at device reserved positions.

11. The display driving device according to claim 10, wherein when a resistor is placed on the first disconnection node and the second disconnection node, the first disconnection node and the second disconnection node are connected.

12. A display device, comprising a display pixel, at least one first driver chip and at least one second driver chip for brightening the display pixel, and a drive controller for driving the first driver chip and the second driver chip to operate; the display device further comprises:
an auxiliary control circuit, connected, when the signal output of the drive controller for driving the first driver chip and the second driver chip to operate is abnormal, to an output terminal of the drive controller, and outputting an auxiliary control signal to perform drive control on the display pixel.

13. The display device according to claim 12, wherein the auxiliary control circuit comprises:
a supplementary signal source, for generating a supplementary power signal; and
a conversion circuit, for receiving the supplementary power signal, and converting the supplementary power signal into the auxiliary control signal.

14. The display device according to claim 13, wherein the conversion circuit comprises:
a first switching circuit, comprising a first control terminal, a first input terminal, and a first output terminal, wherein the first control terminal is electrically connected to an output terminal of the supplementary signal source; the first input terminal is connected to a first input signal source; and the first output terminal is an output terminal of the auxiliary control circuit, and is used to output the auxiliary control signal; and
a second switching circuit, comprising a second control terminal, a second input terminal, and a second output terminal, wherein the second control terminal is electrically connected to an output terminal of the supplementary signal source; the second input terminal is connected to a second input signal source; and the second output terminal is an output terminal of the auxiliary control circuit, and is used to output the auxiliary control signal.

15. The display device according to claim 12, wherein a first disconnection node is disposed between the output terminal of the auxiliary control circuit and the output terminal of the drive controller; and when the signal output of the drive controller is abnormal, the first disconnection node is connected.

16. The display device according to claim 15, wherein a second disconnection node is disposed at the output terminal of the drive controller; and when the signal output of the drive controller is normal, the second disconnection node is connected, and the first disconnection node is disconnected.

17. A display driving module, comprising:
a substrate, forming thereon a display area comprising a plurality of display pixels;
at least one first driver chip, electrically connected to the display pixels in the display area;
at least one second driver chip, electrically connected to the display pixels in the display area;
a drive controller, for generating and correspondingly outputting drive control signals to the first driver chip and/or the second driver chip, controlling the first driver chip and/or the second driver chip to generate drive signals to brighten the display pixels; and
an auxiliary control circuit, connected, when the signal output of the drive controller is abnormal, to an output terminal of the drive controller, and outputting an auxiliary control signal to control the first driver chip and/or the second driver chip to generate the drive signal.

18. The display module according to claim 17, wherein the area beyond the display area of the substrate is a non-display area; the first driver chip and/or the second driver chip are located in the non-display area.

19. The display module according to claim 17, wherein the area beyond the display area of the substrate is a non-display area; and the auxiliary control circuit comprises:
a supplementary signal source, located in a circuit binding area of the non-display area, and generating a supplementary power signal; and
a conversion circuit, located in the non-display area, receiving the supplementary power signal, and converting the supplementary power signal into the auxiliary control signal.

20. The display module according to claim 19, wherein the supplementary signal source comprises a high voltage signal source and a low voltage signal source; the circuit binding area connects an input terminal of the conversion circuit to the corresponding supplementary signal source according to the drive signal required for the first driver chip or the second driver chip.
